(19) United States
(12) Patent Application Publication
(10) Pub. No.: US 2010/0118037 A1
(43) Pub. Date: May 13, 2010

(54) OBJECT-AWARE TRANSITIONS

(75) Inventors: Haroon Saleem Sheikh, Campbell, CA (US); James Eric Tilton, Austin, TX (US)

Correspondence Address: APPLE INC.;c/o Fletcher Yoder, PC, P.O. Box 692289, Houston, TX, 77269-2289, US

(73) Assignee: APPLE INC., Cupertino, CA (US)

(21) Appl. No.: 12/694,222

(22) Filed: Jan. 26, 2010

Related U.S. Application Data
(63) Continuation-in-part of application No. 12/422,808, filed on Apr. 13, 2009.
Application No. 12/422,808 is a continuation-in-part of application No. 12/206,217, filed on Sep. 8, 2008.

(51) Int. Cl. G06T 15/70; G06F 3/14

(52) U.S. Cl. 345/473; 715/730

(57) ABSTRACT

Techniques for accomplishing slide transitions in a presentation are disclosed. In accordance with these techniques, each object on a slide is individually manipulable during slide transitions. In certain embodiments, the presence of an object on both the outgoing and incoming slides may be taken into account during slide transition. Likewise, in certain embodiments, derivative objects, such as shadows or reflections, may be handled as distinct objects in generating a transition between slides.

### CROSS-REFERENCE TO RELATED APPLICATIONS

This application is a continuation-in-part of U.S. patent application Ser. No. 12/422,808 entitled “Object-Aware Transitions”, filed Apr. 13, 2009, which is in turn a continuation-in-part of U.S. patent application Ser. No. 12/206,217, entitled “Object-Aware Transitions”, filed Sep. 8, 2008, both of which are herein incorporated by reference in their entirety for all purposes.

### BACKGROUND

1. Technical Field

The present invention relates generally to transitioning between sequential screens of slideshow presentations.

2. Description of the Related Art

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

One use which has been found for computers has been to facilitate the communication of information to an audience. For example, it is not uncommon for various types of public speaking, (such as lectures, seminars, classroom discussions, keynote addresses, and so forth), to be accompanied by computer generated presentations that emphasize or illustrate points being made by the speaker. For example, such presentations may include music, sound effects, images, videos, text passages, numeric examples or spreadsheets, or audiovisual content that emphasizes points being made by the speaker.

Typically, these presentations are composed of “slides” that are sequentially presented in a specified order. Typically, to transition between slides, a first slide would be replaced by a second slide on the screen. In some circumstances, some form of animation might be performed on the slides as they move on and off. However, the slides themselves are generally static images. Due to the prevalence of such computer-generated and facilitated presentations, one challenge is to maintain the interest level generated by such presentations, i.e., to keep the audience interested in the material being presented on the screen.

### SUMMARY

Certain aspects of embodiments disclosed herein by way of example are summarized below. It should be understood that these aspects are presented merely to provide the reader with a brief summary of certain forms an invention disclosed and/or claimed herein might take and that these aspects are not intended to limit the scope of any invention disclosed and/or claimed herein. Indeed, any invention disclosed and/or claimed herein may encompass a variety of aspects that may not be set forth below.

The present disclosure generally relates to techniques for providing object-aware transitions between slides of a presentation. Such object-aware transitions may include identifying each object on the slides being transitioned in and out. The objects or object-types may then be individually manipulated as part of the transition, such as by application of various effects, That is, the transition process may account for and independently animate or otherwise transition each of the objects or object-types composing the different slides.

In some instances, such object awareness can be leveraged as part of the transition. For example, in one embodiment, the same object, such as a graphic, word, number, or characters in a word or number, may be present in both the outgoing and incoming slides. In one such example, the transition may take advantage of the presence of the common objects in the outgoing and incoming slides to provide an effect or animations specifically for those objects present in both slides. In this way, the presence of the object in both slides may be used to tailor the slide transition.

Further, certain objects may be linked or otherwise associated. For example, a shadow or reflection effect applied to an object may be implemented as a separate shadow object or reflection object (i.e., a derivative object) associated with the primary object in terms of motion, size, and/or position. Further, such derivative objects may themselves be present on both the incoming and outgoing slides to the extent the primary object is common to both slides. Thus, during a slide transition the primary and derivative objects may each be subjected to the same or different effects or animations that transition each object between how it appeared on the outgoing slide to how it appears on the incoming slide.

### BRIEF DESCRIPTION OF THE DRAWINGS

These and other features, aspects, and advantages of the present invention will become better understood when the following detailed description of certain exemplary embodiments is read with reference to the accompanying drawings in which like characters represent like parts throughout the drawings, wherein:

FIG. 1 is a perspective view illustrating an electronic device in accordance with one embodiment;

FIG. 2 is a simplified block diagram illustrating components of an electronic device in accordance with one embodiment;

FIG. 3 depicts a slide including objects in accordance with one embodiment;

FIG. 4 depicts the slide of FIG. 3 undergoing a transition in accordance with one embodiment;

FIGS. 5A-5F depict screenshots of an object-aware slide transition in accordance with one embodiment;

FIGS. 6A-6D depict screenshots of another object-aware slide transition in accordance with one embodiment;

FIGS. 7A-7I depict screenshots of a further object-aware slide transition in accordance with one embodiment;

FIGS. 8A-8F depict screenshots of an additional object-aware slide transition in accordance with one embodiment;

FIGS. 9A-9F depict screenshots of another object-aware slide transition in accordance with one embodiment;

FIG. 10 is a flowchart depicting steps for identifying and matching objects on a pair of slides in accordance with one embodiment;

FIG. 11 is a flowchart depicting additional steps for identifying and matching objects in slides in accordance with one embodiment;

FIG. 12 is a flowchart depicting steps for animating objects during a slide transition in accordance with one embodiment;

FIGS. 13A-13I depict screenshots of an object-aware slide transition with persistent objects in accordance with one embodiment;

FIGS. 14A-14F depict screenshots of another object-aware slide transition with persistent objects in accordance with one embodiment;

FIGS. 15A-15C depict screenshots of an object-aware slide transition with persistent objects and derivative objects in accordance with one embodiment;

FIGS. 16A-16C depict screenshots of another object-aware slide transition with persistent objects and derivative objects in accordance with one embodiment; and

FIGS. 17A-17C depict screenshots of a further object-aware slide transition with persistent objects and derivative objects in accordance with one embodiment.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The disclosure is generally directed to providing object-aware transitions between slides of a presentation. In particular, in accordance with the present disclosure, different objects within each slide (including derivative objects generated that are linked or otherwise associated with other objects) are identified and can be separately and independently handled during slide transitions. In certain embodiments, this involves identifying objects present in both an outgoing and incoming slide and providing specific animation or handling for those objects. With this in mind, an example of a suitable device for use in accordance with the present disclosure is as follows.

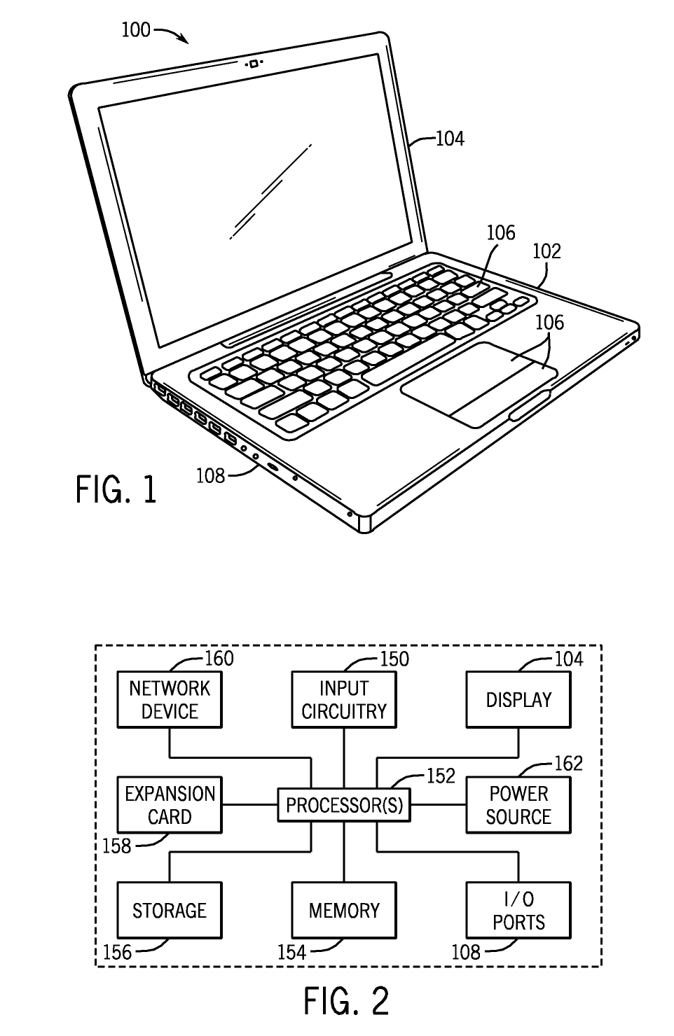

An exemplary electronic device 100 is illustrated in FIG. 1 in accordance with one embodiment of the present invention. In some embodiments, including the presently illustrated embodiment, the device 100 may be processor-based system, such as a laptop, tablet, or desktop computer, suitable for preparing and/or displaying presentations, such as using the Keynote® software package available from Apple Inc as part of the iWork® productivity package. Other processor-based systems suitable for preparing and/or displaying presentations may include servers, thin-client workstations, portable or handheld devices capable of running presentation software, or the like. By way of example, the electronic device 100 may be a model of a MacBook®, MacBook® Pro, MacBook Air®, iMac®, Mac® mini, Mac Pro®, iPhone®, iPod®, or tablet computing device available from Apple Inc. Thus, though FIG. 1 depicts an electronic device 100 in a laptop or notebook computer embodiment, such a depiction is merely for illustration and should not be viewed as limiting. It should be understood that an electronic device 100 may be any device capable of running presentation software, including laptop, tablet, and desktop computer systems as well as handheld and/or portable processor-based systems suitable for running software applications.

In the presently illustrated embodiment, the exemplary electronic device 100 includes an enclosure or housing 102, a display 104, input structures 106, and input/output connectors 108. The enclosure 102 may be formed from plastic, metal, composite materials, or other suitable materials, or any combination thereof. The enclosure 102 may protect the interior components of the electronic device 100 from physical damage, and may also shield the interior components from electromagnetic interference (EMI).

The display 104 may be a liquid crystal display (LCD), organic light emitting diode (OLED) display, cathode ray tube (CRT) or other suitable display type. For example, in one embodiment, a suitable LCD display may be based on light emitting diodes (LED) of compact fluorescent lights providing a backlight that is modulated by pixels of a LCD panel. In one embodiment, one or more of the input structures 106 are configured to control the device 100 or applications running on the device 100. Embodiments of the portable electronic device 100 may include any number of input structures 106, including buttons, switches, a mouse, a control or touch pad, a keyboard, or any other suitable input structures. The input structures 106 may operate to control functions of the electronic device 100 and/or any interfaces or devices connected to or used by the electronic device 100. For example, the input structures 106 may allow a user to navigate a displayed user interface or application interface.

The exemplary device 100 may also include various input and output ports 108 to allow connection of additional devices. For example, the device 100 may include any number of input and/or output ports 108, such as headphone and headset jacks, video ports, universal serial bus (USB) ports, IEEE-1394 ports, Ethernet and modem ports, and AC and/or DC power connectors. Further, the electronic device 100 may use the input and output ports 108 to connect to and send or receive data with any other device, such as a modem, external display, projector, networked computers, printers, or the like. For example, in one embodiment, the electronic device 100 may connect to a scanner, digital camera or other device capable of generating digital images (such as an iPhone or other camera-equipped cellular telephone) via a USB connection to send and receive data files, such as image files.

The electronic device 100 includes various internal components which contribute to the function of the device 100. FIG. 2 is a block diagram illustrating the components that may be present in the electronic device 100 and which may allow the device 100 to function in accordance with the techniques discussed herein. Those of ordinary skill in the art will appreciate that the various functional blocks shown in FIG. 2 may comprise hardware elements (including circuitry), software elements (including computer code stored on a machine-readable medium) or a combination of both hardware and software elements. It should further be noted that FIG. 2 is merely one example of a particular implementation and is merely intended to illustrate the types of components that may be present in a device 100 that allow the device 100 to function in accordance with the present techniques.

In the presently illustrated embodiment, the components may include the display 104 and the I/O ports 108 discussed above. In addition, as discussed in greater detail below, the components may include input circuitry 150, one or more processors 152, a memory device 154, a non-volatile storage 156, expansion card(s) 158, a networking device 160, and a power source 162.

The input circuitry 150 may include circuitry and/or electrical pathways by which user interactions with one or more input structures 106 are conveyed to the processor(s) 152. For example, user interaction with the input structures 106, such as to interact with a user or application interface displayed on the display 104, may generate electrical signals indicative of the user input. These input signals may be routed via the input circuitry 150, such as an input hub or bus, to the processor(s) 152 for further processing.

The processor(s) 152 may provide the processing capability to execute the operating system, programs, user and application interfaces, and any other functions of the electronic device 100. The processor(s) 152 may include one or more microprocessors, such as one or more “general-purpose” microprocessors, one or more special-purpose microprocessors and/or ASICS, or some combination thereof. For example, the processor 152 may include one or more instruction processors, as well as graphics processors, video processors, and/or related chip sets.

As noted above, the components may also include a memory 154. The memory 154 may include a volatile memory, such as random access memory (RAM), and/or a non-volatile memory, such as read-only memory (ROM). The memory 154 may store a variety of information and may be used for various purposes. For example, the memory 154 may store firmware for the electronic device 100 (such as a basic input/output instruction or operating system instructions), other programs that enable various functions of the electronic device 100, user interface functions, processor functions, and may be used for buffering or caching during operation of the electronic device 100.

The components may further include the non-volatile storage 156. The non-volatile storage 156 may include flash memory, a hard drive, or any other suitable optical, magnetic, or solid-state storage medium, or a combination thereof. The non-volatile storage 156 may be used to store data files such as media content (e.g., music, image, video, and/or presentation files), software (e.g., a presentation application for implementing the presently disclosed techniques on electronic device 100), wireless connection information (e.g., information that may enable the electronic device 100 to establish a wireless connection, such as a telephone or wireless network connection), and any other suitable data.

The embodiment illustrated in FIG. 2 may also include one or more card slots. The card slots may be configured to receive an expansion card 158 that may be used to add functionality to the electronic device 100, such as additional memory, I/O functionality, or networking capability. Such an expansion card 158 may connect to the device through any type of suitable connector, and may be accessed internally or external to the enclosure 102. For example, in one embodiment, the expansion card 158 may be a flash memory card, such as a SecureDigital (SD) card, mini- or microSD, CompactFlash card, Multimedia card (MMC), or the like.

The components depicted in FIG. 2 also include a network device 160, such as a network controller or a network interface card (NIC). In one embodiment, the network device 160 may be a wireless NIC providing wireless connectivity over any 802.11 standard or any other suitable wireless networking standard. The network device 160 may allow the electronic device 100 to communicate over a network, such as a Local Area Network (LAN), Wide Area Network (WAN), or the Internet. Further, the electronic device 100 may connect to and send or receive data with any device on the network, such as portable electronic devices, personal computers, printers, and so forth. Alternatively, in some embodiments, the electronic device 100 may not include a network device 160. In such an embodiment, a NIC may be added into card slot 158 to provide similar networking capability as described above.

Further, the components may also include a power source 162. In one embodiment, the power source 162 may be one or more batteries, such as a lithium-ion polymer battery. The battery may be user-removable or may be secured within the housing 102, and may be rechargeable. Additionally, the power source 162 may include AC power, such as provided by an electrical outlet, and the electronic device 100 may be connected to the power source 162 via a power adapter. This power adapter may also be used to recharge one or more batteries if present.

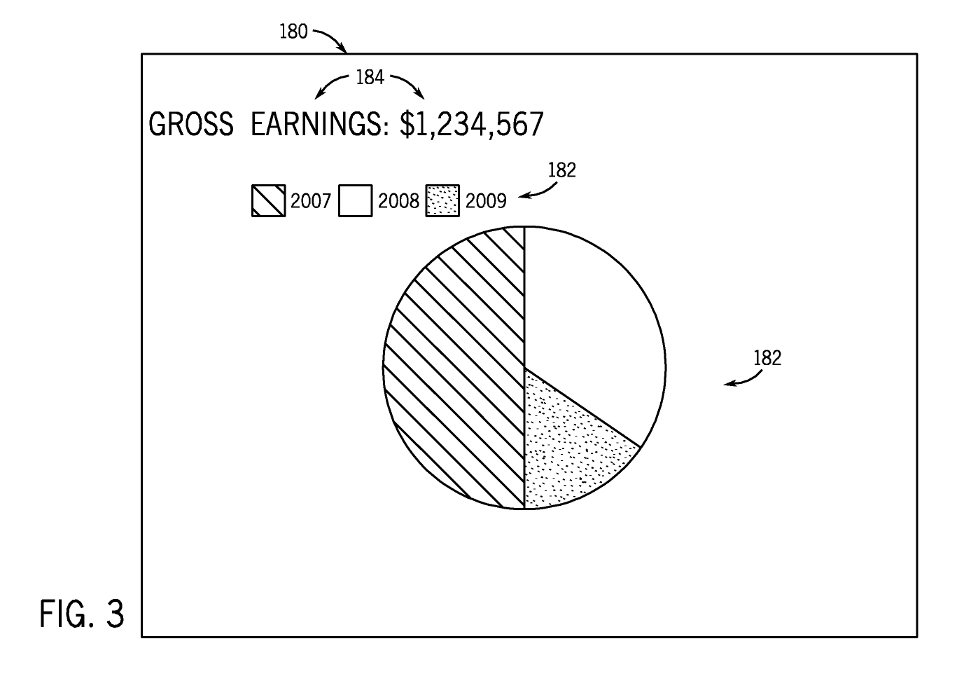

With the foregoing discussion in mind, various techniques and algorithms for implementing aspects of the present disclosure on such devices 100 and accompanying hardware and memory devices are discussed below. Turning to FIG. 3, a slide 180 having graphic objects 182 and character objects 184 (i.e., text and/or numbers or strings of text and/or numbers) is depicted. Such a slide 180 is typically one part of a presentation that typically includes many slides that are sequentially displayed. For example, such a presentation (and the individual slides of the presentation) may be composed in an application (such as Keynote® available from Apple Inc.) suitable for generating and displaying presentations on electronic device 100. In certain embodiments, such applications, or aspects of such applications, may be encoded using a suitable object-oriented programming language, such as Objective-C, C++, C#, and so forth.

As used herein, a “slide” should be understood to refer to a discrete unit on which one or more objects may be placed and arranged. Such slides should also be understood to be discrete units or elements of an ordered or sequential presentation, i.e., the slides are the pieces or units that are assembled and ordered to generate the presentation. Such a slide, may be understood to function as a container or receptacle for a set of objects (as discussed below) that together convey information about a particular concept or topic of the presentation. A slide may contain or include different types of objects (e.g., text, numbers, images, videos, charts, graphs, and/or audio, and so forth) that explain or describe a concept or topic to which the slide is directed and which may be handled or manipulated as a unit due to their being associated with or contained on the slide unit.

The order or sequence of the slides in a presentation or slideshow is typically relevant in that the information on the slides (which may include both alphanumeric (text and numbers) and graphical components) is meant to be presented or discussed in order or sequence and may build upon itself, such that the information on later slides is understandable in the context of information provided on preceding slides and would not be understood or meaningful in the absence of such context. That is, there is a narrative or explanatory flow associated with the ordering or sequence of the slides. As a result, if presented out of order, the information on the slides may be unintelligible or may otherwise fail to properly convey the information contained in the presentation. This should be understood to be in contrast to more simplistic or earlier usages of the term “slide” and “slideshow” where what was typically shown was not a series of multimedia slides containing sequentially ordered content, but projected photos or images which could typically be displayed in any order without loss of information or content.

As used herein, the term “object” refers to any individually editable component on a slide of a presentation. That is, something that can be added to a slide and/or be altered or edited on the slide, such as to change its location, orientation, size, opacity, or to change its content, may be described as an object. For example, a graphic, such as an image, photo, line drawing, clip-art, chart, table, which may be provided on a slide, may constitute an object. Likewise, a character or string of characters may constitute an object. Likewise, an embedded video or audio clip may also constitute an object that is a component of a slide. Therefore, in certain embodiments, characters and/or character strings (alphabetic, numeric, and/or symbolic), image files (.jpg, .bmp, .gif, .tif, .png, .cgm, .svg, .pdf, .wmf, and so forth), video files (.avi, .mov, .mp4, .mpg, .qt, .rm, .swf, .wmv, and so forth) and other multimedia files or other files in general may constitute “objects” as used herein. In certain graphics processing contexts, the term “object” may be used interchangeably with terms such as “bitmap” or texture”.

Further, because a slide may contain multiple objects, the objects on a slide may have an associated z-ordering (i.e., depth) characterizing how the objects are displayed on the slide. That is, to the extent that objects on the slide may overlap or interact with one another, they may be ordered, layered or stacked in the z-dimension with respect to a viewer (i.e., to convey depth) such that each object is ordered as being above or beneath the other objects as they appear on the slide. As a result, in the event of an overlap of objects, a higher object can be depicted as overlying or obscuring a lower object. In this way, a slide may not only have a width and length associated with it, but also a depth (i.e., a z-axis).

Thus, as used herein, the term “slide” should be understood to represent a discrete unit of a slideshow presentation on which objects may be placed or manipulated. Likewise, an “object” as used herein should be understood to be any individually editable component that may be placed on such a slide. Further, as used herein, the term “transition” describes the act of moving from one slide to the next slide in a presentation. Such transitions may be accompanied by animations or effects applied to one or both of the incoming and outgoing slide. Likewise, the term “build” as used herein should be understood as describing effects or animations applied to one or more objects provided on a slide or, in some instances to an object or objects that are present on both an outgoing and incoming slide. For example, an animation build applied to an object on a slide may cause the object to be moved and rotated on the slide when the slide is displayed. Likewise, an opacity build applied to an object on a slide may cause the object to fade in and/or fade out on the slide when the slide is displayed.

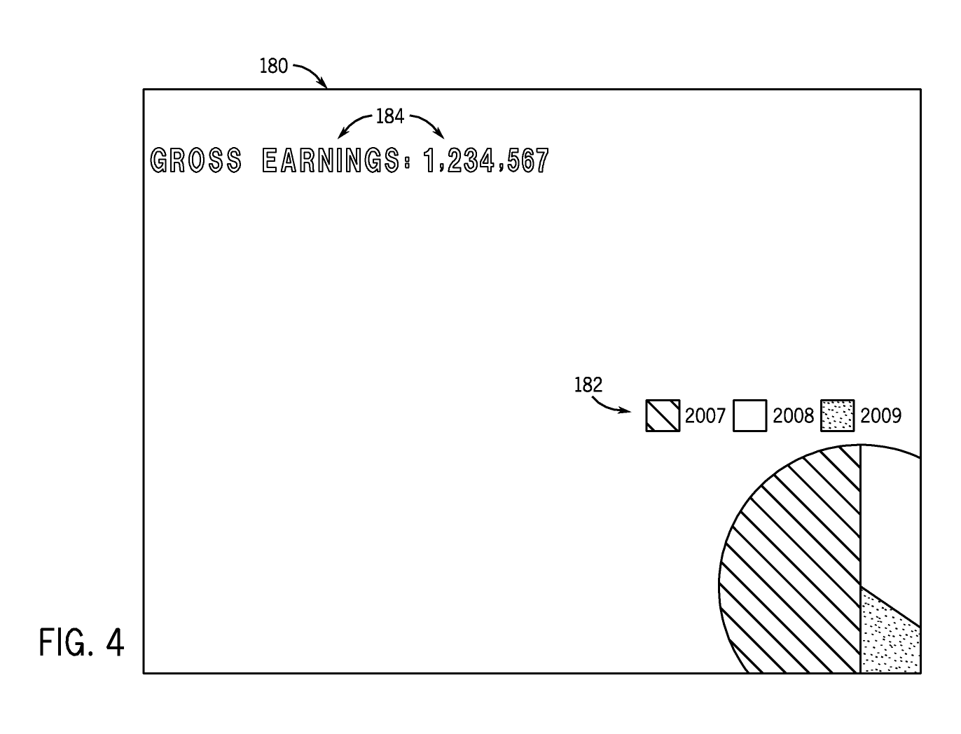

In one embodiment, the objects provided on the slides of a presentation are identified, automatically or by a user, allowing each object to be independently manipulated, such an animated, when transitioning between slides. That is, for a slide being transitioned out, each object may be separately handled, so that different objects or types of objects may undergo a different effect as part of the transition. For example, turning to FIG. 4, text and numeric objects 184 on the slide may fade out as graphic objects 182 are animated off the edges of the slide. Likewise, objects or object types on the incoming slide may also be independently handled, such as by fading in text on the incoming slide and animating the entrance of images of the incoming slide from above or from the sides.

By identifying each object on a slide, effects for transitioning an object on or off the screen may be specified (automatically or by a user) for each object or each type of object (such as graphics files, text boxes, videos, etc.) independently of one another. The effect used in transitioning an object may depend on some characteristic of the object, such as a file type, location on the slide, color, shape, size, and so forth. For example, how close an object is to an edge may be a factor in determining whether the object will be animated on to or off of a slide and, if such an animation is selected, which edge the animation will occur relative to, how fast the animation will occur, and so forth. While the transition effects for different objects or object types may be handled automatically in one embodiment (such as based upon the factors described above), in other embodiments, a user may specify what effects are associated with the transition of an object on or off the screen. For example, a user may use a presentation application interface screen to specify properties of one or more objects on a slide, including transition effects for moving the object on or off the screen.

Such object or content, aware transitions differ from traditional approaches to transition between slides in which each slide is represented by a static image (and, therefore, treated as a single unit) and transitions would generally be an animation between the static images. However, individual objects on the slides were not individually manipulated, such as animated, during transitions. Thus, object-aware transitions, in the present context, are transitions that have access to the different individual objects of which the slides or slides are composed, and where each object can be animated or otherwise manipulated independent of the others.

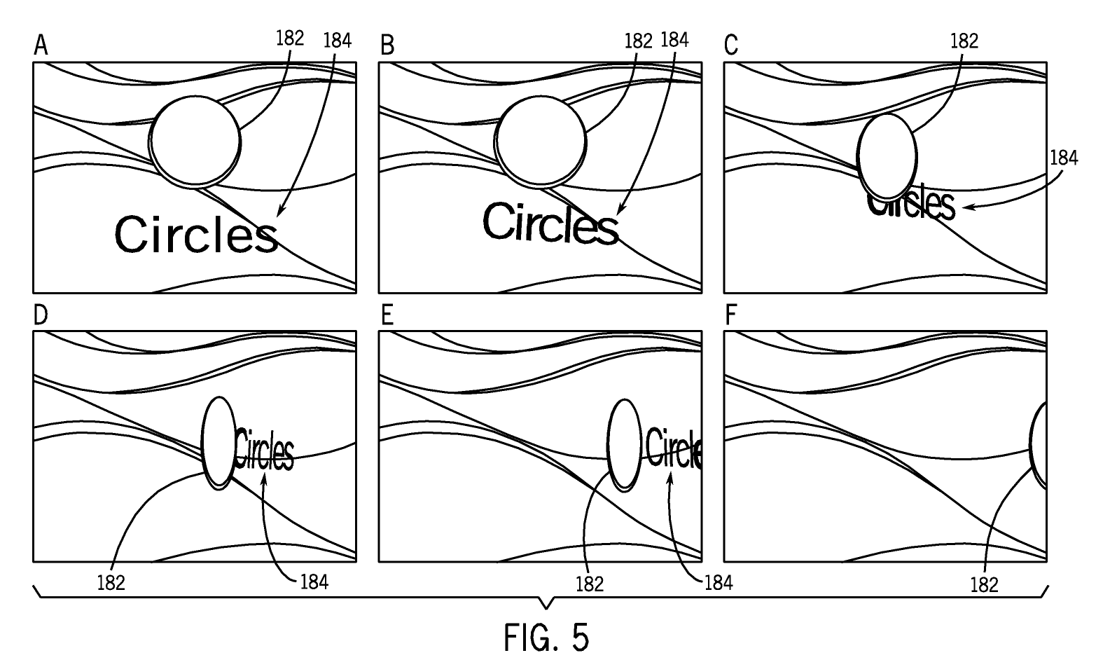

In terms of the various effects that each object can be subjected to in such object-aware transitions, virtually any animation and/or manipulation that can be performed on the respective type of object may be suitable. By way of example, turning now to FIGS. 5A-5F, a sequence of screenshots depicting an example of an animated slide transition is depicted. In this example, the animation may be characterized as a “rotate and slide” animation in which a graphic object 182, here a circle, is “rotated” while “sliding” off of the right side of the slide from the center. Independent of the graphic object 182, a character object 184, here the text string “Circles”, is also rotated and slid off the right of the slide. The character object 184, while rotating and sliding to the right of the slide, is also slid upward from beneath the circle to the vertical center of the slide while being animated off of the slide. Thus, the character object 184 and the graphic object 182 are animated independently of one another such that one object undergoes a different animation, i.e., vertical sliding, in the transition. It is also worth noting that the selected transition, such as “rotate and slide”, may be used to animate in the objects of the next sequential slide. For example, in an incoming slide, a graphic object and character object may be rotated and slid in from the vertical center of the left side of the next slide, with one or both objects also undergoing an upward or downward animation to achieve the desired presentation location on the slide.

In practice, the identification of the graphic and character objects in the slide may be accomplished automatically, such as by an algorithm of a presentation application that identifies such objects by file type extensions or other indicators, or by user designation that the slide component is an object for purposes of object-aware transitions. Once the objects are identified and a transition effect, such as “rotate and slide”, is selected for the slide by the user, the manner in which the selected effect is applied to each object in the slide may be determined automatically. For example, it may be automatically determined that all objects will rotate and slide off of the slide from the vertical center of the slide, and the animation of each object may be determined accordingly. Alternatively, in other embodiments, the user may be able to specify particular effects or animations for each object of the slide, or to specify the manner in which an effect is accomplished, such as with or without vertical centering for an individual object.

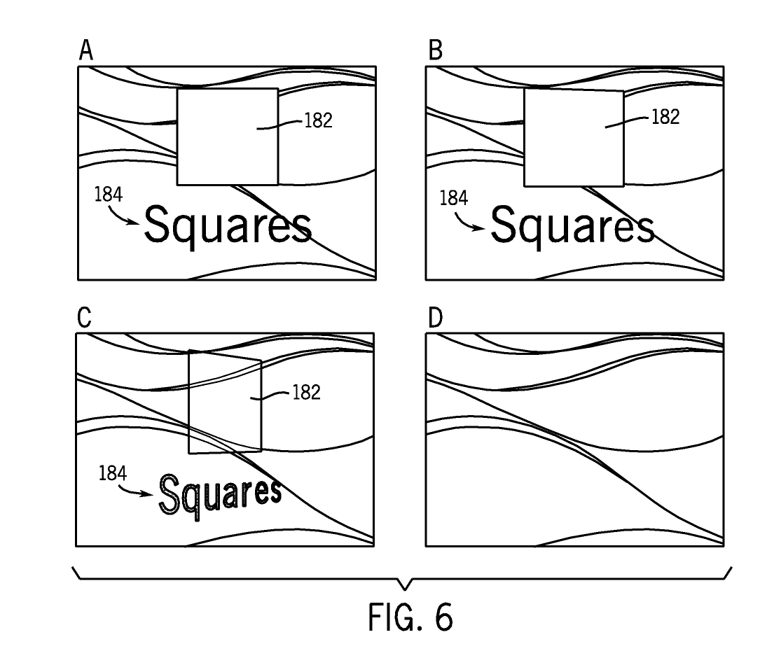

In another example, turning now to FIGS. 6A-6D, a sequence of screenshots depicting another animated slide transition is provided. In this example, the animation may be characterized as a “dissolve and flip” animation in which a graphic object 182, here a square, and a character object 184, here the text string “Squares”, are rotated in place, i.e., flipped, while dissolving or fading from view, such as by progressively increasing the transparency of the objects. As in the previous example, the character object 184 and the graphic object 182 are animated independently of one another. As noted above, the “dissolve and flip” transition may also be used to animate the objects of the next sequential slide to introduce those objects, though obviously in such an implementation, the objects will not be dissolving but appearing or materializing, i.e., opacity will be gradually increased for the objects during the transition.

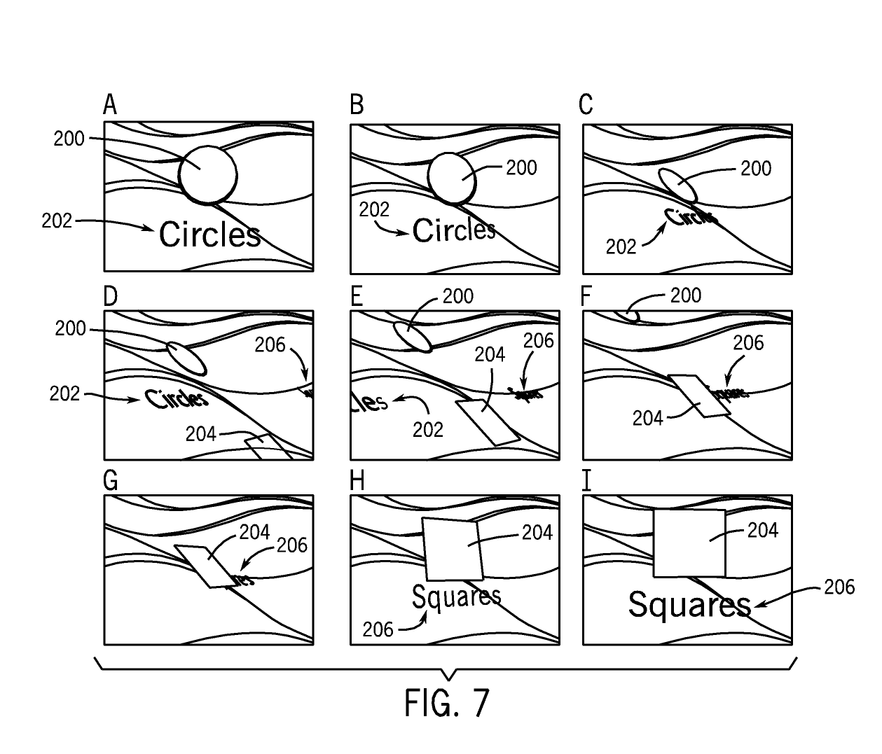

In yet another example, a sequence of screenshots depicting another animated slide transition is depicted in FIGS. 7A-7I. In this example, the animation may be characterized as an “isometric” animation in which, as depicted in FIGS. 7A-7F, a first graphic object 200, here a circle, and a first character object 202, here the text string “Circles”, are subjected to an isometric transformation and moved off the top and left edges, respectively, of a slide. As in the previous example, the first character object 202 and the first graphic object 200 are animated independently of one another, of other objects in the slide, and/or of other objects in the next slide. In addition, the sequence of screenshots depicts, in FIGS. 7D-7I, the animation onto the screen of a second graphic object 204, here a square, and a second character object 206, here the text string “Squares”. In the incoming transition of the second graphic object 204 and the second character object 206, these objects under go the reverse isometric transformation and slide in from opposite respective sides of the screen as their first slide counterparts. As noted above, the “isometric” transition for the incoming slide may also be applied to each object of the incoming slide in an independent manner and/or without regard for the objects of the previous slide.

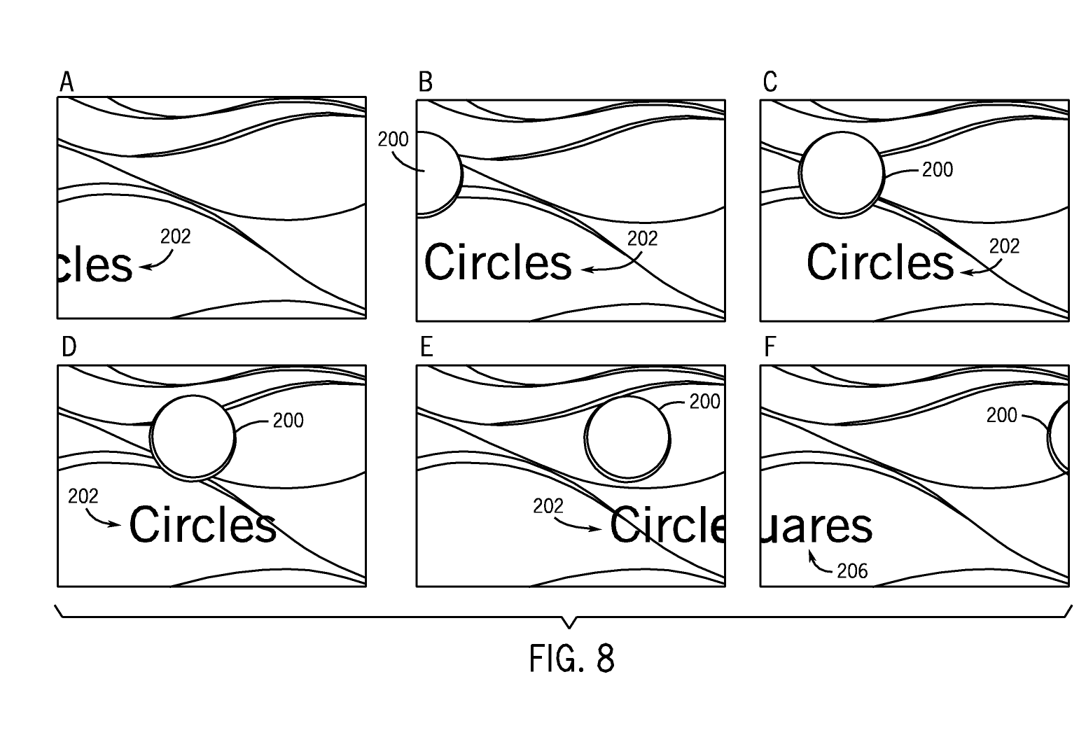

In a further example, a sequence of screenshots depicting another animated slide transition is depicted in FIGS. 8A-8F. In this example, the animation may be characterized as an “object push” animation in which, as depicted in FIGS. 8A-8D, a first graphic object 200, here a circle, and a first character object 202, here the text string “Circles”, are “pushed” in from the left side of the slide. In the depicted example, the first graphic object 200 and the first character object 202 are pushed in at different speeds, e.g., the first graphic object 200 is lagging, though, at the end of the push in animation, the first graphic object 200 is aligned over the center of the first character object 202. Thus, the first character object 202 and the first graphic object 200 move independently of one another, of other objects in the slide, and/or of other objects in the next slide. In addition, the sequence of screenshots depicts, in FIGS. 8E-8F, the first graphic object 200 and the first character object 202 being pushed off the right side of the slide at different speeds, i.e., the graphic is lagging relative to the text, and a second character object 206 associated with the next slide is being pushed onto the slide from the left side. As with the previous slide, the “object push” transition for the incoming slide may also be applied to each object of the incoming slide in an independent manner (such as each object moving at a different speed or entering from a different direction) and/or without regard for the objects of the previous slide.

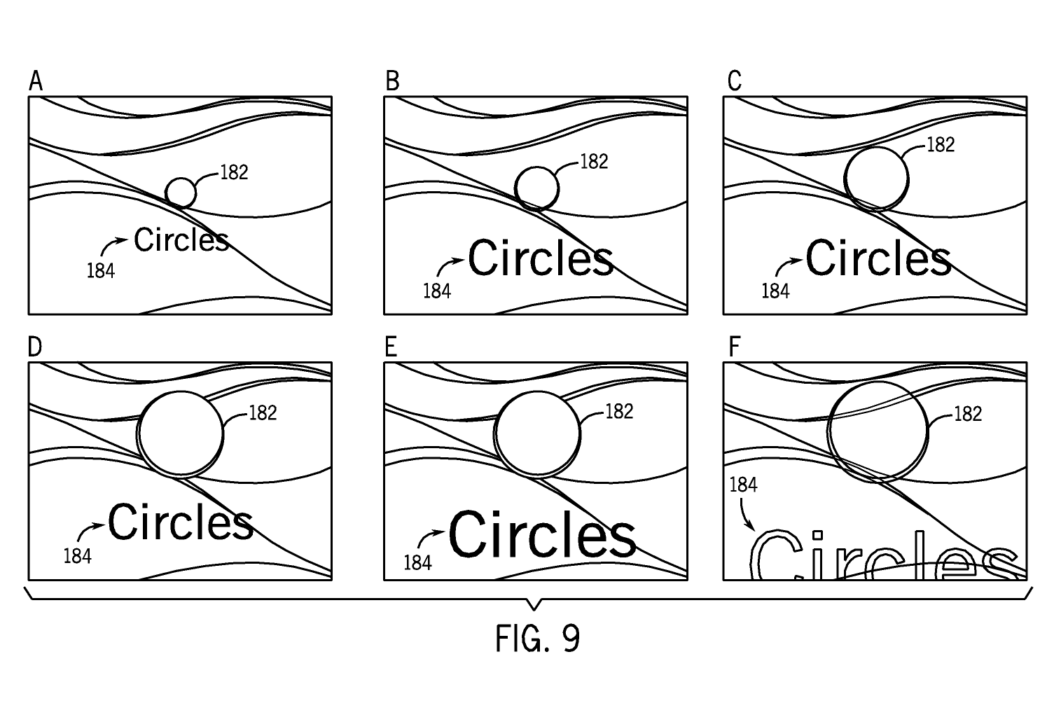

In another example, a sequence of screenshots depicting another animated slide transition is depicted in FIGS. 9A-9F. In this example, the animation may be characterized as an “object zoom” animation in which, as depicted in FIGS. 9A-9D, a graphic object 182, here a circle, and a character object 184, here the text string “Circles”, arise out of the slide. In the depicted example, the graphic object 182 and the character object 184 rise up or appear at different times, i.e., the character object 184 is discernible first. Thus, the character object 184 and the graphic object 182 are animated independently of one another, of other objects in the slide, and/or of other objects in the next slide. In addition, the sequence of screenshots depicts, in FIGS. 9E-9F, the exiting transition of the graphic object 182 and the character object 184 from the slide. In this outgoing transition the graphic object 182 and the character object 184 rise off the surface of the slide until they disappear, with the character object 184 disappearing first. As with the previous slide, the “object zoom” transition for the outgoing objects may be applied to each object in an independent manner (such as each object moving, appearing, or disappearing at a different speed) and/or without regard for the objects of the next slide.

The preceding examples are illustrative of the manner in which individual objects on a slide may be differentially or independently manipulated, e.g., animated, without regard to other objects in a slide. The preceding examples, however, are not exhaustive, and it is to be understood that any animation or manipulation suitable for an object identified in a slide may be applied to that object without regard to the other objects in the slide or the objects in the previous or next slides in certain object-aware transition embodiments.

Further, as previously noted, the identification and assignment of animations may be largely automatic in some embodiments. For example, a user may design two or more sequential slides, such as by placing the desired objects on each slide in the desired locations. The user may then simply select a type of transition, such as the above-described isometric transition, for transitioning between two or more of the slides. In an automated implementation, the presentation application may, knowing only the selected transition and the type and location of the objects on the slides, assign suitable animation direction, speeds, effects, translucencies, and other animation effects to each object being transitioned in and out.

The preceding discussion describes implementations in which the transitions between slides do not take into account what the objects are that are in the slides or whether the same object is present in both the outgoing and incoming slide. However, in certain embodiments, the object-aware transition may take such object persistence into account. For example, in certain implementations where the same object, be it a text, numeric, graphic, and/or video object, is present in consecutive slides, an animation or manipulation may be applied to the object while maintaining the object on the screen. Thus, in one implementation, an object may be present in consecutive slides (though it may be in different locations, orientations, opacities, or at a different scale in the two slides) and an animation may be applied to the object such that the object appears to move, turn, resize, and so forth to reach the appropriate size, location, opacity, and/or orientation in the second slide after the transition.

As in the previously described embodiments, the identification of the object may be performed automatically or based on user inputs. In addition, the determination that the object is present in consecutive slides, though perhaps with different size, opacity, rotation, or location properties, may be performed automatically. For example, the object may be a .jpg or a .gif image which is referenced by a common file name or location (such as an image gallery or library) when placed on the first and second slides or may be a text or numeric object that contains the same characters. Thus, an automated routine may determine that the same image file or character string (word, phrase, sentence, paragraph, and so forth) is present in both slides, even if it is at different locations in the slides or at different sizes. The presentation application may then also evaluate different attributes of the common object, such as size, position, color, rotation, font, and so forth, to determine if any of these attributes that differ between slides would preclude animation from one to the other. If however, the differences are susceptible to a transitional animation, the presentation application may automatically determine an animation for the transition between slides such that the common object appears to be moved, scaled, rotated, and so forth into the proper location for the incoming slide. Thus, in this embodiment, the user may do no more than design two sequential slides with one or more objects in common and the presentation application will identify the common objects on the sequential slides and provide appropriate animated transitions for the common objects when going from the first slide to the second.

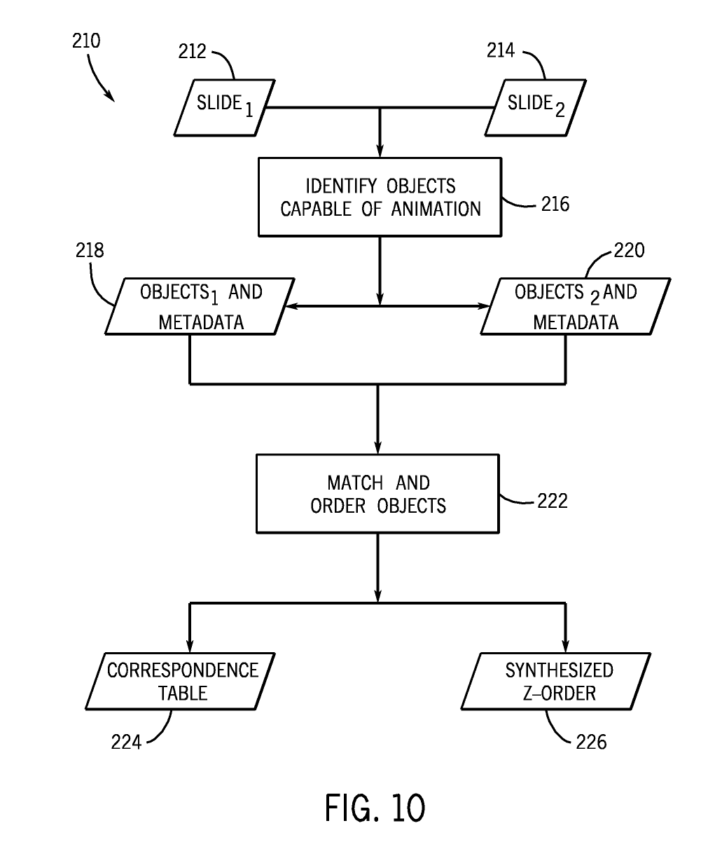

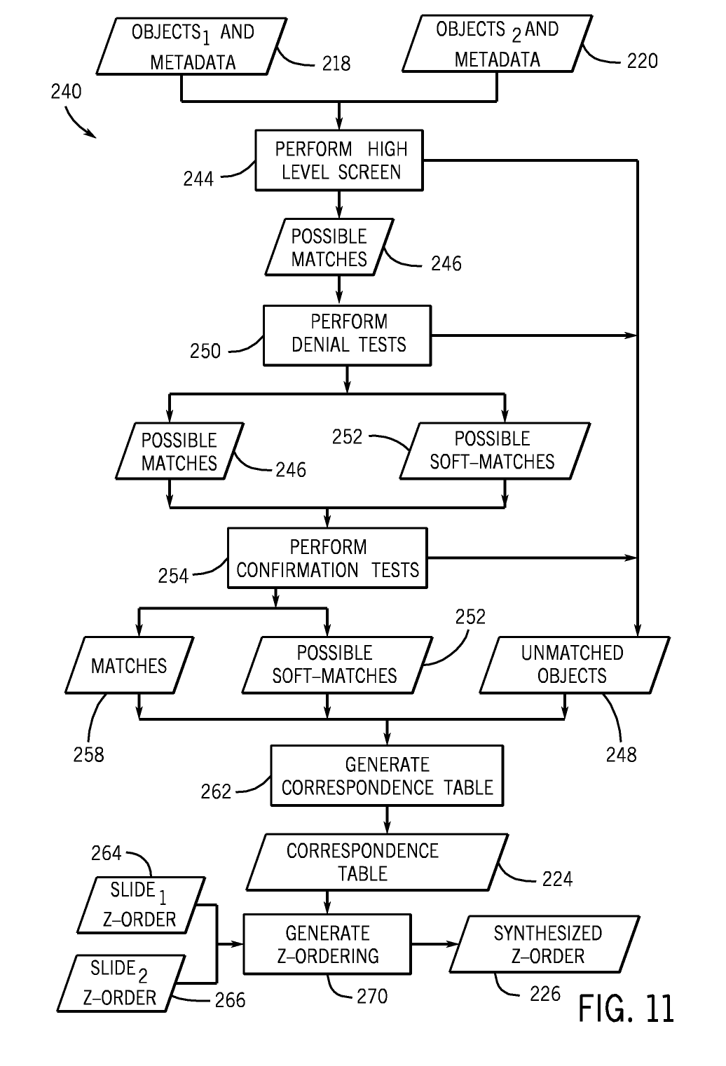

By way of example and turning now to FIG. 10, one example of a technique suitable for automatically identifying and matching objects on an outgoing and an incoming slide is provided. In FIG. 10 a flowchart 210 is provided depicting exemplary inputs, outputs, and processes that may be used in identifying and matching objects in a pair of slides.

In this example, a first slide 212 and a second slide 214 are provided to a routine capable of identifying (block 216) objects that can be animated and of acquiring information (e.g., metadata) associated with each identified object. For example, the identification process may be based on file name extensions, presence of text or characters, and so forth. In some embodiments, identified objects may also be generally characterized or classified based on the identifying feature (such as an image, shape, table, chart, movie, character string, etc.) to facilitate subsequent processing. In addition, as noted above, information or metadata for each identified object may also be determined. Such information or metadata may include, but is not limited to: a filename, a Bezier path describing a custom shape (such as a square, circle, star, and so forth), text attributes (such as automatic capitalization style, font metric information, or the character string itself), shadows and/or reflections applied to the object, masks or alpha masks applied to the object, rotation and/or scaling applied to the object, and so forth.

The objects and associated metadata 218, 220 identified for the respective first and second slides 212, 214 may be used to match and order (block 222) the objects such that objects present in both the first slide 212 and the second slide 214 are identified. For example, the objects identified in the first slide 212 and the second slide 214 may be compared in a pairwise process such that each object is matched with a corresponding object in the other slide or is determined to be present in only the first slide or the second slide (i.e., is unmatched). Based on the matching process, a correspondence table 224 may be generated specifying which objects in the first slide 212 correspond to which objects in the second slide 214.

In certain embodiments, different degrees of matching may be accommodated in the correspondence table 224. For example, an object may be determined to be present in both the first slide 212 and the second slide 214 in an identical form or with only changes in location, rotation, scale, and/or opacity. Such a match may be considered a “hard” or “solid” match in view of the certainty that the object is the same, i.e., is matched, or in view of the relative ease by which the object can be transformed from its form in the first slide 212 to its form in the second slide 214. Further, some metadata may indicate a clear identity match, such as where two image filenames are the same or where two text strings are identical and have the same style and metric information.

In other instances, a match may be construed to be a “soft” match where there is less certainty as to the match and/or where the transformation of the object between the first slide 212 and the second slide 214 is not simply a matter of moving, scaling, rotating or adjusting the opacity of the object. For example, an object in the first slide 212 and an object in the second slide 214 may have generally the same shape but may have different shadow styles, reflection styles, and/or fill styles. Such objects may be deemed to be a soft match in that they may represent the same object in the first and second slides 212, 214 but with some difference or differences that are not resolvable simply by moving, scaling, rotating, and/or changing the opacity of the object.

In addition to establishing the correspondence between objects in the first and second slides 212, 214, the matching and ordering step (block 222) may also establish an ordering 226 of the identified objects in the Z-dimension of the slides, i.e., in the depth dimension with respect to the slides. For example, different effect layers which can be viewed as overlying or underlying a slide may be viewed as being different layers in the Z-dimension. Such a synthesized Z-ordering 226 may be generated using the relative Z-positions of each object on the first slide 212 and/or second slide 214 such that the synthesized Z-ordering 226 provides a transitional or bridge Z-ordering between the two slides that may be used in a transition animation of the matched objects.

Turning now to FIG. 11, one example of a specific implementation of such a matching and ordering process is provided. In the flowchart 240 of FIG. 11, the identified objects and associated metadata 218, 220 for the first and second slides 212, 214 (FIG. 10) may be derived as previously discussed. Both sets of objects 218, 220 may be initially subjected to a high level screen (block 244) based on respective metadata characterizing the different object types (e.g., images, shapes, tables, charts, movies, character strings, and so forth). If an object on one slide can be characterized (based on filename extension or some other suitable metadata) as being a type of object which is not represented on the other slide, the object may be characterized as an unmatched object 248 without further analysis. For example, an object present on the first slide 212 may be characterized as a movie based on a filename extension (e.g., .mov, .avi, .mpg, and so forth). If no object on the second slide 214 is characterized as a movie, no additional analysis is needed to determine that the movie object on the first slide cannot be matched with an object on the second slide since there is no movie on the second slide.

However, if the high level screen (block 244) determines that objects on both the first and second slide 212, 214 may potentially be matches 246 due to the objects being the same type, the objects in question may be characterized as possible matches 246. The possible matches 246 may be subjected to additional analysis to determine if object matches are present in both outgoing and incoming slides. For example, in the depicted embodiment, the possible matches 246 may be subjected (block 250) to denial testing to determine whether objects found in the first and second slide 212, 214 are different from one another.

In one embodiment, such denial testing may be implemented in a pairwise manner, i.e., each object 218 of a given type on the first slide 212 may be compared in a pairwise manner with each object 220 of the same type on the second slide 214. For example, each image object on the first slide 212 may be compared with each image object on the second slide 214 to check for differences between each pair of image objects. Examples of differences which may be checked for include, but are not limited to, differences in the aspect ratios of the objects, different masks associated with the objects, different or dissimilar filenames, and so forth. If an object is determined to be different from every object of the same type in the other slide, the object may be characterized as an unmatched object 248. If an object cannot be unequivocally characterized as different from every object of the same type on the other slide, the object maybe characterized as a possible match 246.

In some embodiments, such as the depicted embodiment, the denial tests (block 250) may merely throw a match in doubt, without ruling a match out. For example, an object on the first slide and an object on the second slide may have different shadow styles, reflection styles, fill styles, and so forth, but may be otherwise similar. Such possible matches may be characterized as “soft” matches 252 in that the objects clearly have some degree of dissimilarity, but not sufficient dissimilarity to state with certainty that the objects are not identical except for some visual distinction, such as shadow, reflection, fill, border thickness, and so forth.

The possible matches 246 and possible soft matches 252 may be further subjected to a confirmation test (block 254) to determine whether objects found in the first and second slide 212, 214 are identical to one another. For example, a confirmation test may verify that text strings found in the first slide 212 and the second slide 214 are identical to one another and/or may verify that the font metric and style information are the same. Likewise, in confirmation testing image objects or movie objects, the confirmation test may confirm that the objects being compared share the same source file (such as by comparing file name and file location). Shape objects may be confirmation tested to confirm that the shape objects have the same border path, and so forth. Group objects may be confirmation tested to confirm that they share the same sub-objects and aspect ratio, and so forth. Failure of a confirmation test may result in an object being classified as an unmatched object 248. A successful confirmation of two objects in different slides may result in those objects being deemed matches 258. In some embodiments, a confirmation test may also deem two objects as a soft match where unequivocal confirmation is not available.

In one embodiment, when an object in the first slide 212 and an object in the second slide 214 successfully pass both denial tests and confirmation tests, the pair of objects may be marked as a set or match 258 and both objects will be removed from further pairwise comparisons. Likewise, if a pair of objects is judged a soft match in either or both of the denial or confirmation test, the pair of objects may be marked as a possible soft match 252. In some embodiments, such soft matched objects may be removed from further comparison while in other embodiments soft matched objects may be subjected to further pairwise comparisons to determine if a full or hard match can be confirmed.

Based on whether an object in the first slide 212 or second slide 214 is classified as being a match with an object in the other slide or as being unmatched with an object in the other slide, a correspondence table 224 may be generated (block 262). Such a correspondence table 224 may, in one embodiment, list each object in the two slides along with an indication of whether or not a match was identified and, if a match was identified, what object in the other slide constitutes the match. Alternatively, the correspondence table may only list the matched objects, with objects not listed on the table being understood to have no match. In embodiments in which soft matches are identified, the correspondence table 224 may contain an additional field or descriptor to indicate that the match is soft, i.e., not exact or identical. Further, in some embodiments, a numeric or quantitative measure of the certainty of the match may be provided in lieu of, or in addition to, a qualitative (i.e., “hard” or “soft”) assessment.

In the depicted example the correspondence table 224, along with the orders 264, 266 of objects in the first and second slides, may be used to generate (block 270) a synthesized Z-order 226 of the objects in the two slides 212, 214. In one example, to establish the synthesized Z-order 226 of the identified objects, the Z-order 264 of the objects identified on the first slide (e.g., the outgoing slide) may be used to initially populate the synthesized Z-order 226. For each unmatched object on the outgoing slide (e.g., first slide 212) a determination may be made of which matched object occurs next in the outgoing slide's Z-order 264 and the respective unmatched object is inserted immediately before that matched object in the synthesized Z-order list 226. The incoming slide (e.g., second slide 214) may be handled similarly, but in reverse order, to maintain the correct relative Z-orders. Once completed, the synthesized Z-order 226 may provide a composite listing of the objects on both the outgoing and incoming slides (i.e., first slide 212 and second slide 214) with the appropriate “depth” or layer for each object on the slides for use in an animated transition between the slides.

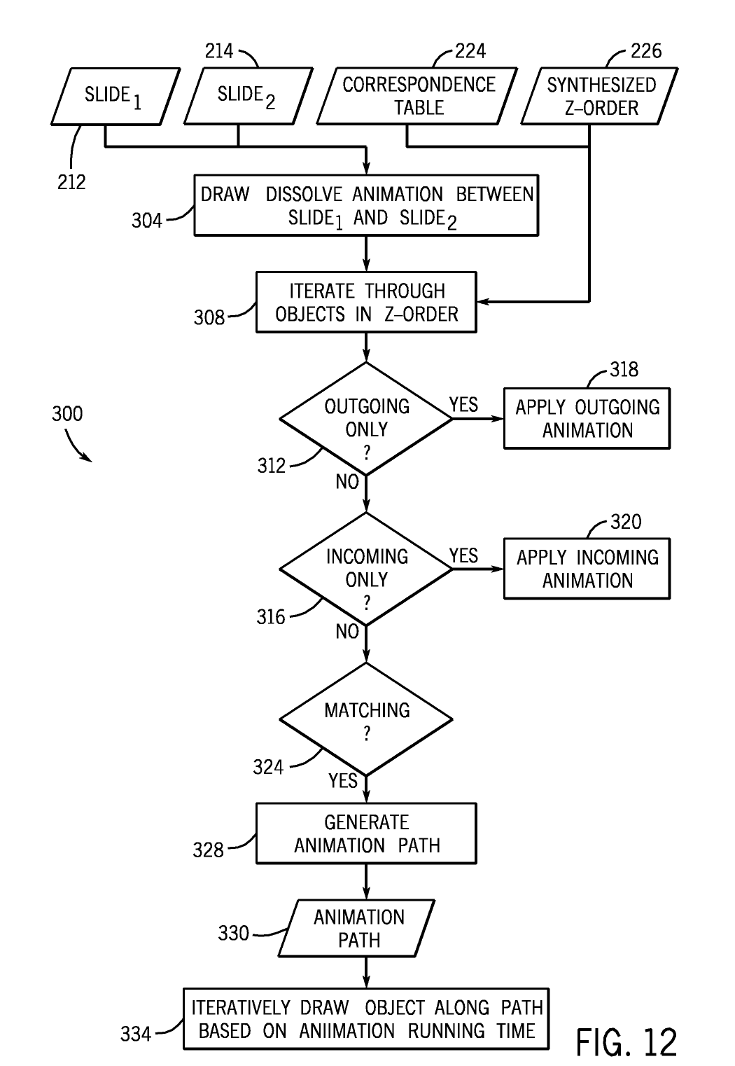

The correspondence table 224 and the synthesized Z-order may be used to generate a series of animation frames for transitioning from the first slide 212 to the second slide 214, as depicted by the flowchart 300 of FIG. 12. As part of one such transitional animation, a dissolve animation may be initially drawn (block 304) between the first slide 212 and the second slide 214. For example, the background of the first slide 212 may be dissolved, i.e., decreased in opacity, while the background of the second slide 214 is materialized, i.e., increased in opacity in the foreground.

In the depicted example, each object on the first slide 212 and the second slide 214 may be iteratively processed (block 308) based on the order specified in the synthesized Z-order 226. As part of the iterative processing, each object may be checked against the correspondence table 224 to determine if it is only on the outgoing slide (e.g., first slide 212), only on the incoming slide (e.g., second slide 214), or on both the outgoing and incoming slides.

If an object is determined (block 312) to be present on only the outgoing slide or is determined (block 316) to be present on only the incoming slide, a specified outgoing animation 318 or incoming animation 320 may be performed on the object. For example, if an object is determined to be only on the outgoing slide, the object may undergo a dissolve animation or an animation moving the object off the screen that occurs over all or part of a specified transition interval. For instance, in one embodiment an object present only on the outgoing slide may have its opacity increased from 0% to 100% over the entire transition interval. Conversely, an object present only in the incoming slide may undergo a materialize animation or an animation moving the object onto the screen over all or part of the specified transition interval. For example, an object present only on the incoming slide may have its opacity decreased from 100% to 0% over the entire transition interval.

In the depicted embodiment, if an object is determined (block 324) to be present in both the outgoing and incoming slides, an animation path 330 is generated (block 328) to transition the object from a final position on the outgoing slide and an initial position on the incoming slide. Information (e.g., metadata) about the object on each slide may be used in generating the animation path 330 to determine if the object has different position, scaling, rotation, and/or opacity on the two slides. If such differences are determined to exist for the object on the two slides, the animation path 330 may include moving, scaling, rotating, and/or changing the opacity of the object from how it appears on the first slide 212 to how it appears on the second slide 214 such that a smooth transition of the object is perceived.

To animate the transition of the object between the first and second slides 212, 214 the object may be iteratively drawn (block 334), i.e., animated, at appropriate positions along the animation path based on the elapsed time of the transition interval. For example, if the specified transition interval is 1 second and the animation is to occur at 60 frames per second, the object will be drawn 60 times during the 1 second transition, with each drawing of the object corresponding to a respective position on the animation path 330. That is, in this example, the first drawing of the object along the animation path 330 will occur at t₁= 1/60th of a second into the transition and will correspond to the object as it appears at a point or step 1/60 of the way along the animation path 330. Likewise, halfway through the transition animation, the object will be drawn at t₃₀=½ of a second into the transition and will correspond to the object as it appears at the halfway point of the animation path 330.

In certain embodiments, the designation of an object match as being a soft match may affect the transition animation. For example, an object present in both the first slide 212 and the second slide 214 may be characterized as a soft match due to having certain dissimilarities in the respective slides that are not sufficient to characterize the objects as unmatched (such as borders of different thickness on two otherwise identical shapes or different filler, shadow, or reflection effects applied to otherwise identical shapes). In one such embodiment, the animation path 330 may include a fade out of the object as it appears on the first slide and a fade in of the object as it appears on the second slide to smoothly fade in the dissimilar features. In such embodiments, shaders or shader functionality provided by a graphics processor or chipset may be used to generate weighted or intermediate images on the animation path 330 that correspond to transitional images of the object as it appears in the first and second slide 212, 214. In this manner, the dissimilarities between the object on the first and second slides 212, 214 may be smoothly faded out or in over the course of the transition animation.

In certain embodiments, the animation of unmatched objects may be handled differently if matched objects are present than when no matched objects are present. For example, in one embodiment, if no matched objects are present on the first slide 212 and the second slide 214, the respective objects may be faded out and faded in over the full transition interval. That is, in such an embodiment, the objects on the outgoing slide may be faded out (i.e., opacity increasing from 0% to 100%) over the full length of the transition interval, such as 2 seconds, while the incoming objects may be materialized (i.e., opacity decreasing from 100% to 0%) over same interval. However, in the presence of one or more matched objects on the first and second slides 212, 214, the animation of the unmatched objects may be altered, such as accelerated. For example, in the presence of one or more matched objects being animated along an animation path 330 during a slide transition, the unmatched objects may be undergo an accelerated, i.e., shorter, fade in or fade out animation. For instance, in such an example an unmatched object being faded out in the presence of matched objects may be faded out by the halfway point of the transition or less, such as by the time 25%, 30%, or 33% of the transition interval has elapsed. Similarly, an unmatched object being faded in in the presence of matched objects may not begin fading in until the halfway point of the transition interval has been reached or later, such as by the time 66%, 70%, or 75% of the transition interval has elapsed.

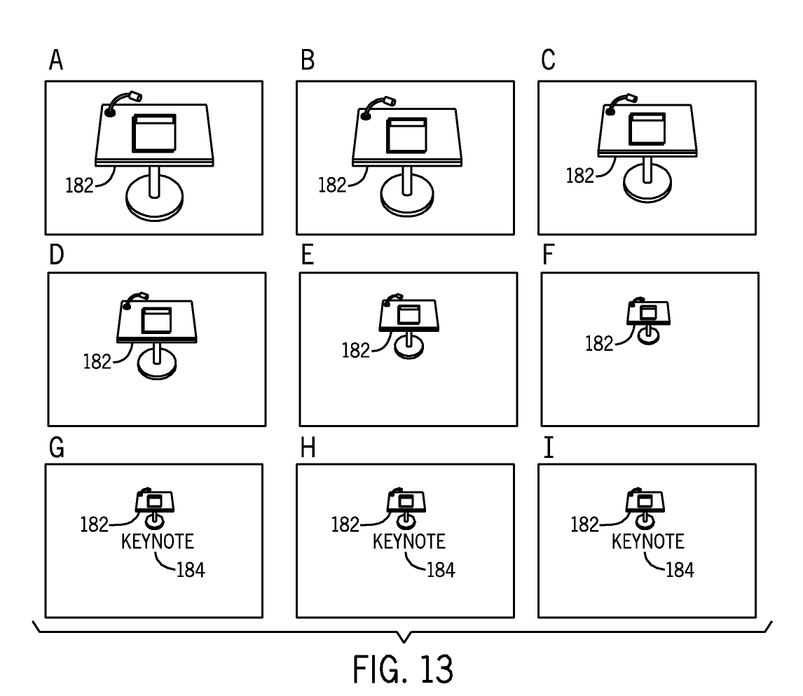

With the foregoing discussion in mind, certain examples of such object-aware transitions are provided where one or more objects are present in both the outgoing and the incoming slide. For example, turning now to FIGS. 13A-13I, a sequence of screenshots depicting a slide transition is depicted. In this example, a graphic object 182, here a stand, is present in both the outgoing and incoming slides. However, the graphic image 182 is at a different size and location in the first slide relative to the second slide. In addition, a character object 184, here the text string “Keynote”, is introduced in the second slide which is not present in the first slide. In the depicted example, the graphic object 182 is animated to appear to shrink and to move upward on the screen as part of the transition between slides. In addition, the character object 184 is added during the transition. As in previous embodiments, the graphic object 182 and character object 184 may be animated or manipulated independently of one another.

In another embodiment of an object-aware transition that takes into account the persistence of objects between slides, a character-based example is provided. In this example, the actual characters, be they letters, numbers, punctuation, etc., on a slide may be evaluated separately for persistence between slides. That is, the characters within a text and/or numeric string may be considered to be the objects in the present context. In an automated implementation, when evaluating the character objects to determine if the character object is present in consecutive slides, the presentation application may evaluate different attributes of the character, such as the letter or number itself, the font, the font size, the color, the presence of certain emphasis (highlight, underlining, italics, bold, strikethrough, and so forth) and other attributes that may affect the similarity of the perceived character in consecutive slides. In certain embodiments, the character might be identical across the evaluated attributes to be retained or animated between slides. In other embodiments, certain attributes, such as color changes, emphases, and so forth, may still allow animation and retention of the character between slides.

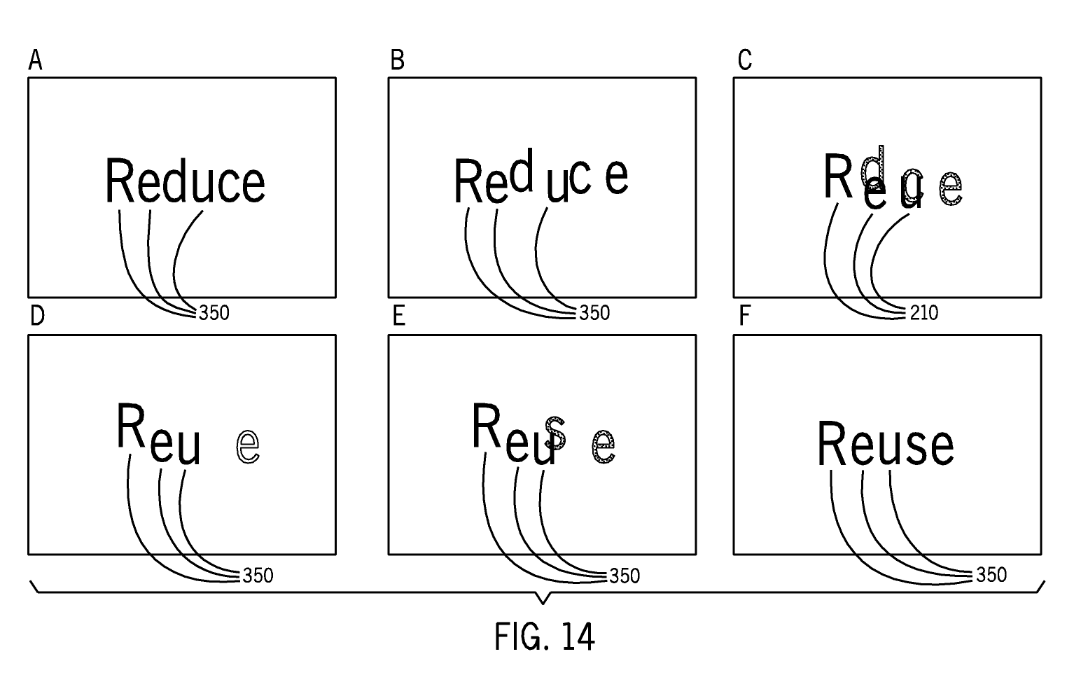

In this example, while the characters may be present in consecutive slides, they need no be used in the same words or numbers, and therefore need not remain in the same order. Turning to FIGS. 14A-14F, a sequence of screenshots depicting a slide transition is depicted. In this example, the character string “Reduce” is initially displayed though, after the slide transition, the character “Reuse” will be displayed. Thus, the persistent character objects 350 “R”, “e”, and “u” are present in both the first and second slide, though there is an intervening “d” in one slide but not the other.

In the depicted example, the non-persistent characters are slid away and faded from view as part of the transition while the persistent character objects 350 remain in view and are slid into their new positions consistent with the word displayed on the second slide. As in previous embodiments, the character objects 350 may be animated or manipulated independently of one another. As will be appreciated, the present example depicts letters, however the characters may also be numbers, symbols, punctuation and so forth. In addition, though the present example described sliding and fading (or retaining) of the characters, in other embodiments other types of character animation may be employed. For example, instead of sliding on the screen, the transition animation may instead rotate or flip the word about a vertical or horizontal axis, with the changes to the word being accomplished during the rotation or flip of the word. Indeed, any suitable form of character animation may be employed in manipulating characters in such an embodiment. Further to the extent that a character or character string may be present multiple times on either or both of the outgoing and incoming slide, in certain embodiments matching processes, such as those described with respect to FIGS. 10 and 11, may take into account the distance between characters or character strings in assigning matches. For example, if multiple possible matches are present for a character string found on the first slide 212 and the second slide 214, one factor in assigning a match may be the distance between the possible matches, with one implementation assigning matches which provide the shortest path moves.

In addition, in further embodiments certain effects that may be applied to or specified for an object (i.e., a primary object) may in turn give rise to a new and separate object (i.e., a derivative object) that remains linked to or otherwise associated with the primary object. For example, an object on a slide, either graphical or textual, may be given a shadow or reflection attribute such that the object is displayed with a shadow or reflection on the slide. In certain approaches, such a shadow or reflection effect may be achieved by modifying or augmenting the primary object to which the effect is assigned, i.e., by modifying the bitmap or texture associated with the object to include the shadow or reflection effect. In one or more embodiments of the present disclosure, assignment of the shadow, reflection, or other effect results in the generation of a new object (i.e., a graphic object) corresponding to the desired shadow or reflection. In one embodiment, the new object is based upon or derived from the object to which the effect has been applied. Hence, the new object may be considered a derivative object with respect to the object to which the effect is assigned, i.e., the primary object.

In one embodiment, such a derivative object may be processed as a separate and independent object. However, in practice such a derivative object may remain linked or associated with the primary object. For example, a derivative object that represents a shadow or reflection will generally be positioned and oriented with respect to the corresponding primary object and whose size (i.e., scale) and shape may be determined by the shape of the primary object. Likewise, changes in opacity to the primary object may result in corresponding changes to the derivative object, i.e., a primary object that is fading from view (i.e., whose opacity is decreasing) will leave less or no shadow or reflection.

Further, the derivative object will typically have a defined relationship in the z-direction with the corresponding primary object. For example, in one embodiment, a derivative object representing a shadow or reflection will typically be immediately adjacent and behind the corresponding primary object with respect to the z-dimension such that other objects cannot be positioned between the primary object and a derivative object representing the shadow or reflection of the primary object. In other embodiments, it may be possible for other objects to be stacked or layered between a primary object and corresponding derivative object such that the derivative object is suitable modified to reflect the intervening object.

Derivative objects, as with any other object, may possess their own parameters that in turn may be modified or specified by the user. For example, a shadow effect (and corresponding shadow object) may be defined by its color, angle (i.e., the angle the shadow projects outward with respect to the primary object), offset (i.e., perceived separation between the object and its shadow), blur (i.e., perceived sharpness at the edge of the shadow), and/or opacity which may all be specified by the user. The shape, scale, position, and rotation of the shadow object will generally be defined by the corresponding attributes of the relevant primary object, taking into account the shadow parameters (such as offset and angle) specified for the shadow effect. Likewise, a reflection effect (and corresponding reflection object) may be defined by its opacity, projection angle, and/or blur which may all be specified by the user. The shape, scale position, and rotation of the reflection object will generally be defined by the corresponding attributes of the relevant primary object, taking into account the reflection parameters (such as angle) specified for the reflection effect.

Because the derivative objects generated in response to effects such as shadow and reflection constitute objects as discussed herein, such derivative objects may also be subject to the various transitional effects discussed herein. For example, to the extent that a derivative object is present on only one of an incoming or outgoing slide, its introduction or exit may be animated accordingly during a slide transition, keeping in mind that the corresponding primary object will be present when the derivative object is present. Further, to the extent that a derivative object is present on both an outgoing and incoming slide, a slide transition may be performed which animates the appearance of the derivative object in the outgoing slide to the appearance of the derivative object in the incoming slide.

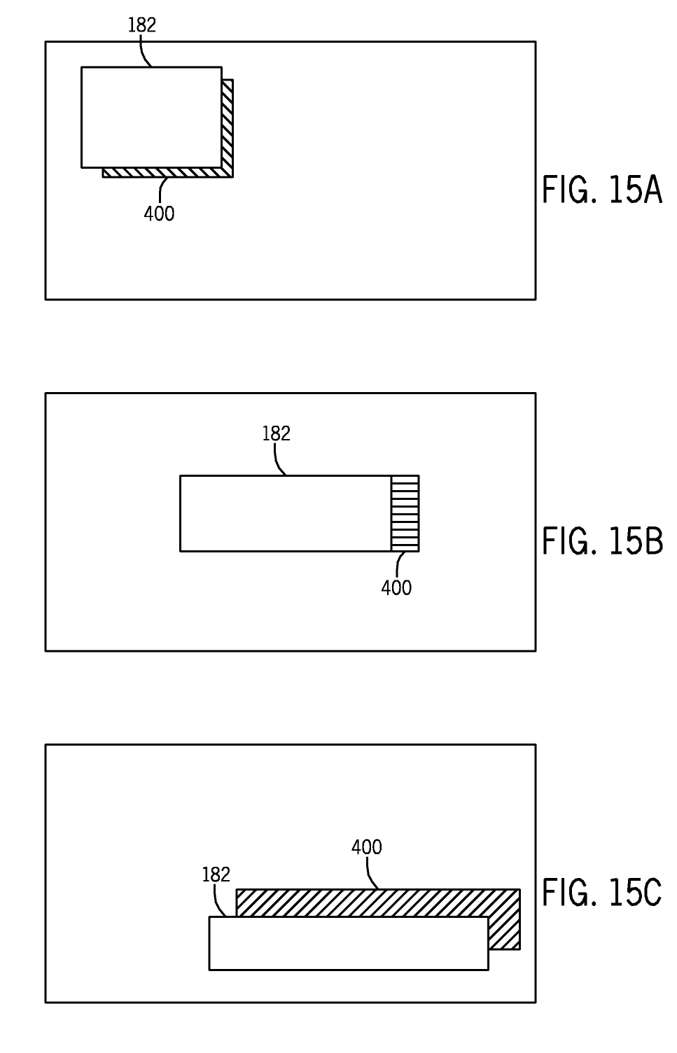

For example, turning to FIG. 15A-C, a slide transition is depicted in which a graphic object 182 is present on both the outgoing and incoming slides, though the position and shape of the graphic object 182 is different on the incoming and outgoing slides. In the depicted example, a shadow effect is applied graphic object 182, giving rise to the derivative object 400 which represents a shadow of the graphic object 182. As with the graphic object 182 with which it is associated, the derivative object 400 is changed between the outgoing and incoming slides. In particular, the angle, offset, and opacity (signified by the different types hatching) parameters of the derivative object 400 are different in the incoming and outgoing slides, as is the position of the derivative object 400, though this position is generally determined based upon the position of the primary graphic object 182.

For example, referring to FIG. 15A, the derivative object 400 is specified as projecting downward and to the right of the primary object (i.e., the angle of the shadow is approximately 135° assuming the top of the slide represents 0°) with a given offset and opacity. As depicted in FIG. 15C, the parameters of the derivative object 400 (i.e., the shadow effect) are altered such that the shadow is specified as projecting upward and to the right (at approximately 45°) with a greater offset and a different opacity (as indicated by the different hatching). The position of the derivative object 400 has also changed and may be determined based upon the position of the graphic object 182 (i.e., the primary object) and the specified angle and offset of the shadow effect.

FIG. 15B depicts an intermediate frame of an animation used to transition between the outgoing slide positions represented in FIG. 15A and the incoming slide position represented in FIG. 15C. Based on the positions and properties of the graphic object 182 and derivative object 400 the intermediate frame represented by FIG. 15B may be automatically generated by suitable code executing on a processor based system (i.e., electronic device 100) as discussed herein. In particular, FIG. 15B represents intermediate positions and values for the appearance of the graphic object 182 and derivative object 400 between their respective appearances in the outgoing and incoming slides. As depicted in FIG. 15B, the graphic object is depicted as elongating and translating down and rightward to its position and appearance in the incoming slide (as depicted in FIG. 15C). Likewise, the derivative object 400 (i.e., the shadow effect) associated with the graphic object 182 is depicted as pointing rightward (i.e., approximately 90°), increasing in offset, and increasing in opacity (as indicated by the different hatching). Thus, FIG. 15B represents an intermediate step in how the graphic object 182 and derivative object 400 appear in the outgoing slide and how they appear in the incoming slide.

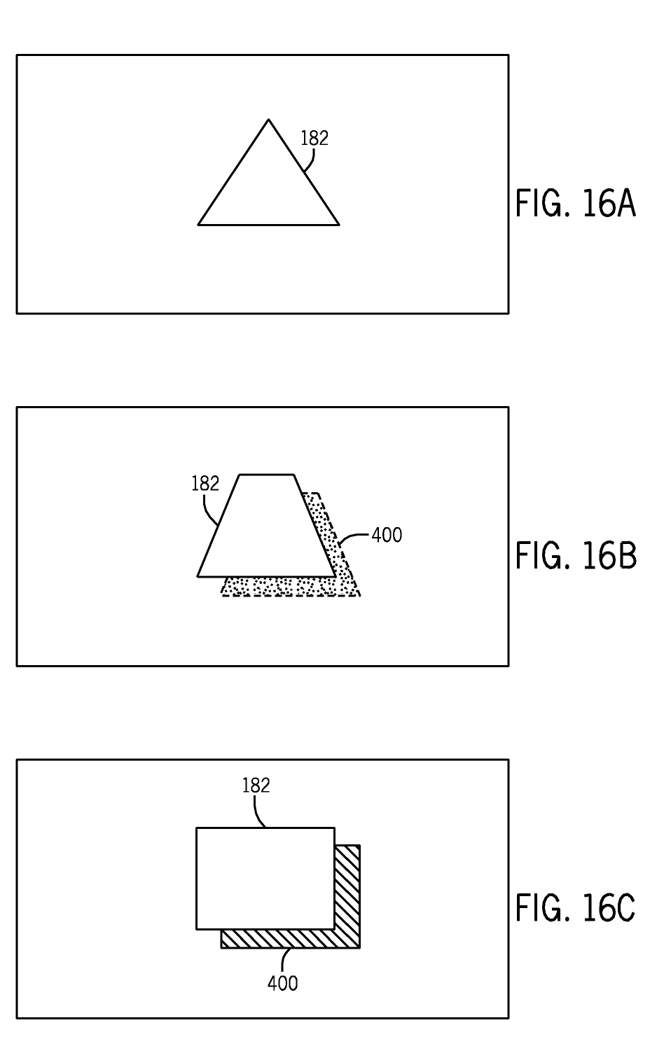

Likewise, referring to FIGS. 16A-C a slide transition is depicted in which a graphic object 182 is present on both the outgoing and incoming slides, though the shape of the graphic object 182 is different on the incoming and outgoing slides. In the depicted example, a shadow effect is applied graphic object 182 as it appears in the incoming slide, but not in the outgoing slide, giving rise to the derivative object 400 in the incoming slide that represents a shadow of the graphic object 182.

In one embodiment, the derivative object 400 may only exist in the incoming slide and may thus be faded in or otherwise introduced as any new object that is present on the incoming slide but not the outgoing slide. However, in the depicted embodiment, the derivative object 400 is portrayed as transitioning from the outgoing slide to the incoming slide, i.e., the derivative object is treated as being on both the incoming slide and the outgoing slide. Such an implementation may be achieved, in one embodiment, by generating one or more derivative objects 400 (i.e., shadow effects) for each object present on a slide. In one such embodiment, the derivative object 400, when not active on the slide, may have position and/or parameters such that it essentially corresponds to the primary object (i.e., identical position, no offset, no angle, and so forth). Further, when the respective effect (e.g., shadow or reflection) is not active for an object, the opacity of the corresponding derivative object may be set at 0%, i.e., the corresponding derivative object is not visible on a slide. However, as here, upon introduction of the derivative object 400, the opacity of the derivative object 400 may be gradually increased to fade in the effect. In one embodiment, other parameters of the derivative object (e.g., offset, angle, color, and so forth) may be animated to gradually transition the derivative object 400 from its hidden position to its position on an incoming slide.

Turning back to FIGS. 16A-C, both the graphic object 182 and the derivative object 400 are changed between the outgoing and incoming slides. In particular, the angle, offset, and opacity (signified by the different types hatching) parameters of the derivative object 400 are different in the incoming and outgoing slides, as is the position of the derivative object 400. In particular, in the outgoing slide (depicted in FIG. 16A) the derivative object 400 is not visible (i.e., opacity of 0%) and/or corresponds to the position of the graphic object 182 (i.e., identical position, no angle, no offset).

As depicted in FIG. 16C, the parameters of the derivative object 400 (i.e., the shadow effect) are altered such that the shadow is specified as projecting downward and to the right (at approximately 135°) with an offset and opacity greater than 0. FIG. 16B depicts an intermediate frame of an animation used to transition between the outgoing slide positions represented in FIG. 16A and the incoming slide position represented in FIG. 16C. Based on the positions and properties of the graphic object 182 and derivative object 400 the intermediate frame represented by FIG. 16B may be automatically generated by suitable code executing on a processor based system (i.e., electronic device 100) as discussed herein. In particular, FIG. 16B represents intermediate positions and values for the appearance of the graphic object 182 and derivative object 400 between their respective appearances in the outgoing and incoming slides, assuming that the derivative object 400 is present but not visible in the outgoing slide as depicted in FIG. 16A and corresponds with the position, shape, rotation, and size of the primary object, here graphic object 182. As depicted in FIG. 16B, the graphic object 182 is depicted as changing shape to correspond to its position and appearance in the incoming slide (as depicted in FIG. 16C). Likewise, the shadow derivative object 400 associated with the graphic object 182 is depicted as extending rightward and downward (i.e., approximately 135°), increasing in offset, and increasing in opacity (as indicated by the different hatching) to become visible. Thus, FIG. 16B represents an intermediate step in how the graphic object 182 and derivative object 400 appear in the outgoing slide and how they appear in the incoming slide.

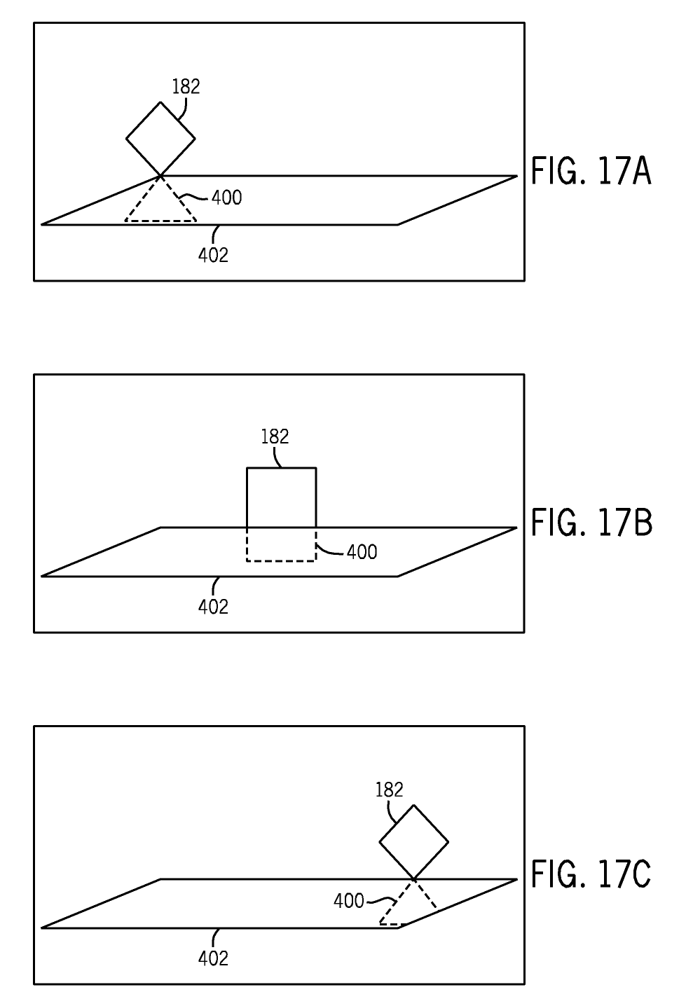

While the preceding examples describe embodiments in which the derivative objects 400 represent a shadow effect applied to a primary object, the derivative object 400 may also represent other types of visual effects linked to or associated with a primary object. For example, FIGS. 17A-C depict a slide transition in which a graphic object 182 is present on both the outgoing and incoming slides, though the position and shape of the graphic object 182 is different on the incoming and outgoing slides. In the depicted example, a reflection effect is applied graphic object 182, giving rise to the derivative object 400 which represents a reflection of the graphic object 182. As with the graphic object 182 with which it is associated, the derivative object 400 has changed position between the outgoing and incoming slides. Further, as discussed below, the graphic object 182 is rotated in the process of changing position from that depicted in FIG. 17A to the position depicted in FIG. 17C.

For example, referring to FIG. 17A, the derivative object 400 is depicted as a reflection of the graphic object 182 on a reflective plane 402. As depicted in FIG. 17C, the parameters of the derivative object 400 (i.e., the reflection effect) are generally unchanged, though a piece of the reflected image is missing due to the shape and position of the reflective plane 402. However, the position of the derivative object 400 has changed in response tot eh change in position of the graphic object 182.

FIG. 17B depicts an intermediate frame of an animation used to transition between the outgoing slide positions represented in FIG. 17A and the incoming slide position represented in FIG. 17C. In this example, a rotation of the graphic object 182 (and, correspondingly, of derivative object 400) has been specified as part of the slide transition. Based on the positions and properties of the graphic object 182 and derivative object 400 the intermediate frame represented by FIG. 17B may be automatically generated by suitable code executing on a processor based system (i.e., electronic device 100) as discussed herein. In particular, FIG. 17B represents intermediate positions and values for the appearance of the graphic object 182 and derivative object 400 between their respective appearances in the outgoing and incoming slides and incorporating the specified rotational effect. Thus, FIG. 17B represents an intermediate step in how the graphic object 182 and derivative object 400 appear in the outgoing slide and how they appear in the incoming slide.

For the purpose of illustration, the preceding examples have depicted graphical objects in the form of shapes to simplify explanation. However, it should be appreciated that derivative objects as described herein (e.g., objects generated in response to shadow or reflection effects) may correspond to other types of primary objects such as (but not limited to) alphanumeric characters (e.g., text), images, drawings, tables, charts, and various other types of visually depicted objects.

In addition, it should be appreciated that other concepts discussed herein, such as the concepts of hard and soft matches and the attendant animations that may be generated for soft matches as compared to hard matches, are equally applicable to derivative objects as discussed herein. For example, in the context of a shadow effect, the corresponding derivative object may be defined by parameters such as color, angle, offset, blur, opacity, and position. In such an example, differences in angle, offset, opacity, and/or position for a derivative object present in both an outgoing and incoming slides may still be allow the derivative object to be classified as a hard match. However, differences in blur and/or color for a derivative object present in both the outgoing and incoming slides may result in the derivative object being classified as a soft match, with corresponding adjustments being made to the transitional animation process when needed.

Further, it should be appreciated that the identification and matching processes discussed herein may be modified to leverage the known relationship between a derivative object and a corresponding primary object. That is, if a primary object is identified in both the outgoing and incoming slide and a shadow or reflection effect is applied to the primary object in both the outgoing and incoming slide, the corresponding derivative objects (e.g. shadows or reflections) can be matched to one another, even if the appearance of the derivative object is different in the two slides. Conversely, in one embodiment derivative objects associated with different primary objects will not be matched and can generally be clearly categorized as different objects. Likewise, for matching purposes, if a primary object is present in only one of an incoming or outgoing slide, a derivative object associated with the primary object will only be present in the slides in which the primary object is present.

As will be appreciated, the present techniques allow for identification of objects on slides of a presentation and the independent manipulation, such as animation, of the objects during slide transitions. As described herein, in some embodiments, no weight is given as to whether the same object or objects are present in consecutive slides. However, in other embodiments, the presence of an object or objects in consecutive slides may be noted and manipulation of the objects during slide transition may take advantage of the persistence of the objects. In certain embodiments, as described herein, the identification of objects and/or the transitional manipulation of the identified objects may be automatically derived, such as by a presentation application executing on a processor-based system. Further, in certain embodiments, the matching and animation processes will accommodate derivative objects generated in response to effects, such as shadow and reflection effects, applied to other objects on a slide or slides.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method for generating an effect for an object on a slide, comprising:
receiving an input assigning an effect to an object on a slide of a slideshow presentation; and
generating a derivative object associated with the object, wherein the derivative object comprises one or more attributes determined at least in part by one or more corresponding attributes of the object, wherein the derivative object is a separate and distinct object from the object.

2. The method of claim 1, wherein the object and the derivative object have different respective z-locations.

3. The method of claim 1, wherein the derivative object corresponds to a shadow of the object or a reflection of the object.

4. The method of claim 1, wherein the one or more attributes of the derivative object determined at least in part by the one or more corresponding attributes of the object comprise one of more of shape, rotation, and position.

5. The method of claim 1, wherein derivative object and the object are adjacent in the z-direction.

6. The method of claim 1, wherein a bitmap defining the object is not modified by the effect.

7. A method for animating an object, comprising:
determining that an object is present on an outgoing slide and on an incoming slide;
determining that a derivative object associated with the object is present on the outgoing slide and on the incoming slide;
generating a first animation transitioning the object from how it appears on the outgoing slide to how it appears on the incoming slide;
generating a second animation transitioning the derivative object from how it appears on the outgoing slide to how it appears on the incoming slide;
displaying the first animation and the second animation when transitioning between the outgoing slide and the incoming slide.

8. The method of claim 7, comprising:
identifying the objects on the outgoing slide and the objects on the incoming slide;
performing a comparison of the objects on the outgoing slide and the objects on the incoming slide when determining that the object is present on the outgoing slide and on the incoming slide.

9. The method of claim 7, wherein the derivative object comprises a graphic object representing a shadow or a reflection of the object.

10. The method of claim 7, wherein the object comprises a graphic or one or more characters.

11. The method of claim 7, wherein the second animation changes one or more of the position, color, angle, offset, blur, or opacity of the derivative object.

12. The method of claim 7, wherein determining that the object or the derivative object is present on the outgoing slide and on the incoming slide comprises consulting a correspondence table listing objects on the outgoing slide and the incoming slide.

13. The method of claim 7, wherein the second animation for transitioning the derivative object comprises one or more of a change in position, a change in scale, a change in rotation, a change in opacity, a change in offset, a change in color, or a change in projection angle with respect to the object.

14. A method for animating transitions between slides of a computer-implemented slide show presentation, comprising:
determining whether a derivative object is present on a first slide and on a second slide, wherein the derivative object represents an effect applied to a primary object;
generating an animation path for the derivative object if the derivative object is present on both the first slide and the second slide, wherein the animation path animates a transition of the derivative object from the first slide to the second slide; and
rendering the derivative object along the animation path during a slide transition.

15. The method of claim 14, wherein the animation path comprises one or more of moving, rotating, resizing, changing an opacity, changing a color, changing a projection angle, changing an offset, or changing a blur associated with the derivative object to resolve differences between the derivative object as presented on the first slide and as presented on the second slide.

16. The method of claim 12, wherein rendering the derivative object comprises iteratively drawing the object along the animation path based on a projected animation run time.

17. The method of claim 12, wherein determining whether the derivative object is present on the first slide and on the second slide comprises classifying the derivative object on the first slide as being a match or a soft match with the object on the second slide.

18. Computer-readable media comprising a computer program product, the computer program product comprising routines which, when executed on a processor, perform the following:
matching a derived object present on a first slide with the derived object if present on a second slide of a multi-slide presentation, wherein the derived object is derived based upon a visual effect applied to an associated primary object;
generating an animation that transitions the derived object from how the derived object appears on the first slide to how the derived object appears on the second slide; and
displaying the animation when the first slide transitions to the second slide during the multi-slide presentation.

19. The computer-readable media of claim 18, wherein the visual effect applied to the associated primary object is a shadow effect or a reflection effect.

20. The computer-readable media of claim 18, wherein derived object represents a shadow or a reflection of the associated primary object.

21. The computer-readable media of claim 18, wherein displaying the animating comprises rendering the derived object in step-wise increments determined based upon a transition time, a refresh rate, and an animation path.
